(19) United States
(12) Patent Application Publication
(10) Pub. No.: US 2024/0089940 A1
(43) Pub. Date: Mar. 14, 2024

(54) CONFIGURE IAB FREQUENCY-DOMAIN RESOURCE UTILIZATION

(71) Applicant: TELEFONAKTIEBOLAGET LM ERICSSON (PUBL), STOCKHOLM (SE)

(72) Inventors: Yezi Huang, TÄBY (SE); Boris Dortschy, VENDELSÖ (SE); Magnus Åström, LUND (SE); Lei Bao, GÖTEBORG (SE); Behrooz Makki, PIXBO (SE)

(21) Appl. No.: 18/272,066

(22) PCT Filed: Jan. 12, 2022
(86) PCT No.: PCT/EP2022/050498

§ 371 Date: Jul. 12, 2023

Related U.S. Application Data
(60) Provisional application No. 63/136,475, filed on Jan. 12, 2021.

(51) Int. Cl. H04W 72/0453; H04W 72/27; H04W 76/10

(52) U.S. Cl. CPC H04W 72/0453; H04W 72/27; H04W 76/10; H04W 92/20

(57) ABSTRACT

Systems and methods for configuration of Integrated Access and Backhaul (IAB) frequency-domain resource utilization are disclosed. In one embodiment, a method performed by a network node that implements a centralized network function unit for frequency-domain resource utilization configuration of an IAB node comprises determining a configurable frequency part size(s) for a frequency-domain resource utilization configuration of an IAB node and determining a mode of frequency-domain resource utilization for each of at least some of a plurality of frequency parts of an available bandwidth of the IAB node, the available bandwidth being divided into the plurality of frequency parts in accordance with the configurable frequency part size(s). The method further comprises sending the frequency-domain resource utilization configuration to the IAB node.

### RELATED APPLICATIONS

This application claims the benefit of provisional patent application Ser. No. 63/136,475, filed Jan. 12, 2021, the disclosure of which is hereby incorporated herein by reference in its entirety.

### TECHNICAL FIELD

The present disclosure relates to an Integrated Access and Backhaul (IAB) network and, more specifically, to resource coordination between a Mobile Termination (MT) and a Distributed Unit (DU) co-located within an IAB node.

### BACKGROUND

Densification via the deployment of an increasing number of base stations, be them macro or micro base stations, is one of the mechanisms that can be employed to satisfy the ever-increasing demand for more and more bandwidth/capacity in mobile networks. Due to the availability of more spectrum in the millimeter wave (mmw) band, deploying small cells that operate in this band is an attractive deployment option for these purposes. However, deploying fiber to the small cells, which is the usual way in which small cells are deployed, can end up being very expensive and impractical. Thus, employing a wireless link for connecting the small cells to the operator's network is a cheaper and practical alternative with more flexibility and shorter time-to-market. One such solution is an Integrated Access and Backhaul (IAB) network, where the operator can utilize part of the radio resources for the backhaul link.

In FIG. 1, an IAB deployment that supports multiple hops is presented. The IAB donor node (in short IAB donor) has a connection to the core network, and the IAB nodes are wirelessly connected using, in this example, Third Generation Partnership Project (3GPP) New Radio (NR) to the IAB donor, either directly or indirectly via another IAB node. The connection between IAB donor/node and User Equipments (UEs) is called an access link, whereas the connection between two IAB nodes or between an IAB donor and an IAB node is called a backhaul link.

Furthermore, as shown in FIG. 2, the adjacent upstream node (which is closer to the IAB donor node) of an IAB node is referred to as a parent node or parent IAB node of the IAB node. The adjacent downstream node (which is further away from the IAB donor node) of an IAB node is referred to as a child node or child IAB node of the IAB node. The backhaul link between the parent node and the IAB node is referred to as parent (backhaul) link, whereas the backhaul link between the IAB node and the child node is referred to as child (backhaul) link.

As one major difference of the IAB architecture compared to a 3GPP Release 10 Long Term Evolution (LTE) relay (besides lower layer differences) is that the IAB architecture adopts the Central-Unit/Distributed-Unit (CU/DU) split of NR base stations (gNBs) in which time-critical functionalities are realized in the DU closer to the radio, whereas the less time-critical functionalities are pooled in the CU with the opportunity for centralization. Based on this architecture, an IAB-donor contains both CU and DU functions. In particular, it contains all CU functions of the IAB nodes under the same IAB-donor. Each IAB node then hosts the DU function(s) of a gNB. In order to be able to transmit/receive wireless signals to/from the upstream IAB node or IAB-donor, each IAB node has a mobile termination (MT), a logical unit providing a necessary set of UE-like functions. Via the DU, the IAB node establishes Radio Link Control (RLC) channels to UEs and/or to MTs of the connected IAB node(s). Via the MT, the IAB node establishes the backhaul radio interface towards the serving IAB node or IAB-donor. FIG. 3 shows a reference diagram for a two-hop chain of IAB nodes under an IAB-donor.

Wireless backhaul links are vulnerable to blockage, e.g., due to moving objects such as vehicles, due to seasonal changes (foliage), severe weather conditions (rain, snow, or hail), or due to infrastructure changes (new buildings). Such vulnerability also applies to IAB nodes. Also, traffic variations can create uneven load distribution on wireless backhaul links leading to local link or node congestion. In view of those concerns, the IAB topology supports redundant paths as another difference compared to the Release 10 LTE relay.

The following topologies are considered in IAB as shown in FIG. 4:
1. Spanning Tree (ST), and
2. Directed Acyclic Graph (DAG).
   These topologies mean that one IAB node can have multiple child nodes and/or have multiple parent nodes. The multi-connectivity or route redundancy may be used for back-up purposes. It is also possible that redundant routes are used concurrently, e.g., to achieve load balancing, reliability, etc.

In regard to resource configuration and, in particular, time-domain resource coordination, in case of in-band operation, the IAB node is typically subject to the half-duplex constraint, i.e., an IAB node can only be in either transmission or reception mode at a time. Release 16 IAB mainly considers the time-division multiplexing (TDM) case where the MT and DU resources of the same IAB node are separated in time. Based on this consideration, the following resource types have been defined for IAB MT and DU, respectively.

From an IAB node MT point-of-view, as in Release 15, the following time-domain resources can be indicated for the parent link:
Downlink (DL) time resource
Uplink (UL) time resource
Flexible (F) time resource

From an IAB node DU point-of-view, the child link has the following types of time resources:
DL time resource
UL time resource
F time resource
Not-available (NA) time resources (resources not to be used for communication on the DU child links)

Each of the downlink, uplink, and flexible time-resource types of the DU child link can belong to one of two categories:
Hard (H): The corresponding time resource is always available for the DU child link
Soft (S): The availability of the corresponding time resource for the DU child link is explicitly and/or implicitly controlled by the parent node.

The IAB DU resources are configured per cell, and the H/S/NA attributes for the DU resource configuration are explicitly indicated per-resource type (D/U/F) in each slot. As a result, the semi-static time-domain resources of the DU part can be of seven types in total: Downlink-Hard (DL-H), Downlink-Soft (DL-S), Uplink-Hard (UL-H), Uplink-Soft (UL-S), Flexible-Hard (F-H), Flexible-Soft (F-S), and Not-Available (NA). The coordination relation between MT and DU resources are listed in Table 1.

TABLE 1
Coordination between MT and DU resources of an IAB node.

| | | MT configuration | | |
|---|---|---|---|---|
| | | DL | UL | Flexible |
| DU | DL-H | DU: can transmit on | DU: can transmit on | DU: can transmit on |
| configuration | | DL unconditionally; | DL unconditionally; | DL unconditionally; |
| | | MT: not available. | MT: not available. | MT: not available. |
| | DL-S | DU: can transmit | DU: can transmit | DU: can transmit |
| | | conditionally; | conditionally; | conditionally; |
| | | MT: available on DL. | MT: available on UL. | MT: available on DL |
| | | | | & UL. |
| | UL-H | DU: can schedule UL | DU: can schedule UL | DU: can schedule UL |
| | | unconditionally; | unconditionally; | unconditionally; |
| | | MT: not available. | MT: not available. | MT: not available. |
| | UL-S | DU: can schedule UL | DU: can schedule UL | DU: can schedule UL |
| | | conditionally; | conditionally; | conditionally; |
| | | MT: available on DL. | MT: available on UL. | MT: available on DL |
| | | | | & UL. |
| | F-H | DU: can transmit on | DU: can transmit on | DU: can transmit on |
| | | DL or schedule UL | DL or schedule UL | DL or schedule UL |
| | | unconditionally; | unconditionally; | unconditionally; |
| | | MT: not available. | MT: not available. | MT: not available. |
| | F-S | DU: can transmit on | DU: can transmit on | DU: can transmit on |
| | | DL or schedule UL | DL or schedule UL | DL or schedule UL |
| | | conditionally; | conditionally; | conditionally; |
| | | MT: available on DL. | MT: available on UL. | MT: available on DL |
| | | | | & UL. |
| | NA | DU: not available; | DU: not available; | DU: not available; |
| | | MT: available on DL. | MT: available on UL. | MT: available on DL |
| | | | | & UL. |

Furthermore, a DU function may correspond to multiple cells, including cells operating on different carrier frequencies. Similarly, an MT function may correspond to multiple carrier frequencies. This can either be implemented by one MT unit operating on multiple carrier frequencies, or be implemented by multiple MT units, each operating on different carrier frequencies. The H/S/NA attributes for the per-cell DU resource configuration should take into account the associated MT carrier frequency(ies).

One example of such DU configuration is in FIG. 5.

In regard to resource configuration and, in particular, frequency-domain resource configuration, one of the objectives in the Release 17 IAB Work Item Description (WID) RP-201293 is to have “specification of enhancements to the resource multiplexing between child and parent links of an IAB node, including: support of simultaneous operation (transmission and/or reception) of IAB node's child and parent links (i.e., MT Tx/DU Tx, MT Tx/DU Rx, MT Rx/DU Tx, MT Rx/DU Rx).”

One idea for such enhancement is to provide frequency-domain resource configuration. Comparing to the time-domain counterpart, one example of the frequency-domain DU resource configuration is shown in FIG. 6.

### SUMMARY

Systems and methods for configuration of Integrated Access and Backhaul (IAB) frequency-domain resource utilization are disclosed. In one embodiment, a method performed by a network node that implements a centralized network function unit for frequency-domain resource utilization configuration of an IAB node comprises determining a configurable frequency part size(s) for a frequency-domain resource utilization configuration of an IAB node and determining a mode of frequency-domain resource utilization for each of at least some of a plurality of frequency parts of an available bandwidth of the IAB node, the available bandwidth being divided into the plurality of frequency parts in accordance with the configurable frequency part size(s). The method further comprises sending the frequency-domain resource utilization configuration to the IAB node, the frequency-domain resource utilization configuration comprising information that indicates the mode of frequency-domain resource utilization for each of the at least some of the plurality of frequency parts of the available bandwidth of the IAB node. In this manner, high flexibility for configuring frequency-domain resource utilization at an IAB node to enable efficient frequency multiplexing is provided.

In one embodiment, the frequency-domain resource utilization configuration of the IAB node comprises one or more of a frequency-domain resource utilization configuration for a Distributed Unit (DU) of the IAB node, a frequency-domain resource utilization configuration for a Mobile Termination (MT) of the IAB node, or a frequency-domain resource utilization configuration for an access link between the IAB node and a User Equipment (UE).

In one embodiment, determining the mode of frequency-domain resource utilization for each of the at least some of the plurality of frequency parts of the available bandwidth of the IAB node comprises determining the mode of frequency-domain resource utilization for each of the plurality of frequency parts of the available bandwidth of the IAB node, and the frequency-domain resource utilization configuration comprises information that indicates the mode of frequency-domain resource utilization for each of the plurality of frequency parts of the available bandwidth of the IAB node.

In one embodiment, for each frequency part of the at least some of the plurality of frequency parts of the available bandwidth of the IAB node, the mode of frequency-domain resource utilization for the frequency part is either Hard, Soft, or Not Available.

In one embodiment, determining the configurable frequency part size for the frequency-domain resource utilization configuration of the IAB node comprises determining the configurable frequency part size for the frequency-domain resource utilization configuration of the IAB node such that the configurable frequency part size is a multiple of a size of a frequency part used for communication among the network node, a parent IAB node of the IAB node, a MT of the IAB node, a child IAB node of the IAB node, and/or a wireless communication device in a respective cellular communications system.

In one embodiment, determining the configurable frequency part size for the frequency-domain resource utilization configuration of the IAB node comprises determining the configurable frequency part size for the frequency-domain resource utilization configuration of the IAB node such that the configurable frequency part size is a multiple of a size of a resource block group (RBG).

In one embodiment, determining the configurable frequency part size for the frequency-domain resource utilization configuration of the IAB node comprises determining the configurable frequency part size for the frequency-domain resource utilization configuration of the IAB node such that the configurable frequency part size is one or more consecutive resource blocks in the frequency-domain.

In one embodiment, determining the configurable frequency part size for the frequency-domain resource utilization configuration of the IAB node comprises determining the configurable frequency part size for the frequency-domain resource utilization configuration of the IAB node based on information about a frequency-domain resource condition between the MT of the IAB node and a DU of the IAB node. In one embodiment, the MT of the IAB node establishes a communication interface or channel towards a parent IAB node and the DU of the IAB node establishes a communication interface or channel to a wireless communication device and/or establishes a communication interface or channel to the MT of a child IAB node.

In one embodiment, determining the configurable frequency part size for the frequency-domain resource utilization configuration of the IAB node comprises determining the configurable frequency part size for the frequency-domain resource utilization configuration of the IAB node based on information about a desired configurable frequency part size of the IAB node.

Corresponding embodiments of a network node are also disclosed. In one embodiment, a network node that implements a centralized network function unit for frequency-domain resource utilization configuration of an IAB node is adapted to determine a configurable frequency part size(s) for a frequency-domain resource utilization configuration of an IAB node and determine a mode of frequency-domain resource utilization for each of at least some of a plurality of frequency parts of an available bandwidth of the IAB node, the available bandwidth being divided into the plurality of frequency parts in accordance with the configurable frequency part size(s). The network node is further adapted to send the frequency-domain resource utilization configuration to the IAB node, the frequency-domain resource utilization configuration comprising information that indicates the mode of frequency-domain resource utilization for each of the at least some of the plurality of frequency parts of the available bandwidth of the IAB node.

In one embodiment, a network node that implements a centralized network function unit for frequency-domain resource utilization configuration of an IAB node comprises processing circuitry configured to cause the network node to determine a configurable frequency part size(s) for a frequency-domain resource utilization configuration of an IAB node and determine a mode of frequency-domain resource utilization for each of at least some of a plurality of frequency parts of an available bandwidth of the IAB node, the available bandwidth being divided into the plurality of frequency parts in accordance with the configurable frequency part size(s). The processing circuitry is further configured to cause the network node to send the frequency-domain resource utilization configuration to the IAB node, the frequency-domain resource utilization configuration comprising information that indicates the mode of frequency-domain resource utilization for each of the at least some of the plurality of frequency parts of the available bandwidth of the IAB node.

Embodiments of a method performed by an IAB node are also disclosed. In one embodiment, a method performed by an IAB node comprises receiving a frequency-domain resource utilization configuration from a network node, the frequency-domain resource utilization configuration comprising information that indicates a mode of frequency-domain resource utilization for each of at least some of a plurality of frequency parts of an available bandwidth of the IAB node. The method further comprises determining a frequency-domain resource usage of a MT of the IAB node and a DU of the IAB node based on the frequency-domain resource utilization configuration.

In one embodiment, the MT of the IAB node establishes a communication interface or channel towards a parent IAB node, and the DU of the IAB node establishes a communication interface or channel to a wireless communication device and/or establishes a communication interface or channel to a MT of a child IAB node.

In one embodiment, the method further comprises operating in accordance with the determined frequency-domain resource usage.

In one embodiment, for each frequency part of the at least some of the plurality of frequency parts of the available bandwidth of the IAB node, the mode of frequency-domain resource utilization for the frequency part is either Hard, Soft, or Not Available.

In one embodiment, the frequency-domain resource utilization configuration comprises information that indicates the mode of frequency-domain resource utilization for each of the plurality of frequency parts of the available bandwidth of the IAB node.

In one embodiment, a size of the plurality of frequency parts is configurable.

In one embodiment, a size of the plurality of frequency parts is a multiple of a size of a frequency part used for communication among the network node, a parent IAB node of the IAB node, the MT of the IAB node, a child IAB node of the IAB node and/or a wireless communication device in a respective cellular communications system.

In one embodiment, a size of the plurality of frequency parts is a multiple of a size of a RBG.

In one embodiment, each frequency part of the plurality of frequency parts is one or more consecutive resource blocks in the frequency-domain.

In one embodiment, a size of the plurality of frequency parts is based on a frequency-domain resource condition between the MT of the IAB node and the DU of the IAB node.

In one embodiment, a size of the plurality of frequency parts is based on information about a desired configurable frequency part size of the IAB node.

In one embodiment, the method further comprises sending, to a network node, information about a frequency-domain resource condition between the MT of the IAB node and the DU of the IAB node.

In one embodiment, the method further comprises sending, to a network node, information about a desired frequency part size of the IAB node.

In one embodiment, determining the frequency-domain resource usage of the MT of the IAB node and the DU of the IAB node comprises determining, based on the frequency-domain resource utilization configuration, that there is interference between the mode of frequency-domain resource utilization configuration of a frequency part at the DU and the mode of frequency-domain resource utilization configuration of an adjacent frequency part at the MT, and responsive thereto, performing one or more actions to determine the frequency-domain resource usage in such a manner as to mitigate the interference. In one embodiment, for a frequency part that is indicated by the frequency-domain resource utilization configuration as a Hard resource, performing one or more actions to determine the frequency-domain resource usage in such a manner as to mitigate the interference comprises determining to use the frequency part according to its configuration as a Hard resource irrespective of an impact of such use on an ability of the MT to transmit or receive in the same frequency part only if such use does not impact an ability of the MT to transmit and receive in any other frequency part. In another embodiment, for a frequency part that is indicated by the frequency-domain resource utilization configuration as a Soft resource, performing the one or more actions to determine the frequency-domain resource usage in such a manner as to mitigate the interference comprises determining to use the frequency part according to its configuration as a Soft resource only if such use does not impact an ability of the MT to transmit or receive in any frequency part. In another embodiment, for a frequency part that is indicated by the frequency-domain resource utilization configuration as a Not Available resource, performing the one or more actions to determine the frequency-domain resource usage in such a manner as to mitigate the interference comprises determining not to use the frequency part according to its configuration as a Not Available resource. In another embodiment, for a frequency part that is indicated by the frequency-domain resource utilization configuration as a Hard resource, performing the one or more actions to determine the frequency-domain resource usage in such a manner as to mitigate the interference comprises determining to use the frequency part according to its configuration as a Hard resource irrespective of an impact of such use on an ability of the MT to transmit or receive in any frequency part. In another embodiment, for a frequency part that is indicated by the frequency-domain resource utilization configuration as a Soft resource, performing the one or more actions to determine the frequency-domain resource usage in such a manner as to mitigate the interference comprises determining to use the frequency part according to its configuration as a Soft resource only if such use does not impact an ability of the MT to transmit or receive in the same frequency part.

In one embodiment, performing the one or more actions to determine the frequency-domain resource usage in such a manner as to mitigate the interference comprises sending, to the network node or a parent node of the IAB node, information about one or more desired guard bands that mitigate the interference and receiving, from the network node or the parent node of the IAB node, information about one or more provided guard bands that are based on the one or more desired guard bands. Determining the frequency-domain resource usage of the MT of the IAB node and the DU of the IAB node comprises determining the frequency-domain resource usage of the MT of the IAB nod and the DU of the IAB node comprises based on the information about the one or more provided guard bands.

Corresponding embodiments of an IAB node are also disclosed. In one embodiment, an IAB node is adapted to receive a frequency-domain resource utilization configuration from a network node, the frequency-domain resource utilization configuration comprising information that indicates a mode of frequency-domain resource utilization for each of at least some of a plurality of frequency parts of an available bandwidth of the IAB node. The IAB node is further adapted to determine a frequency-domain resource usage of MT of the IAB node and a DU of the IAB node based on the frequency-domain resource utilization configuration.

In one embodiment, an IAB node comprises processing circuitry configured to cause the IAB node to receive a frequency-domain resource utilization configuration from a network node, the frequency-domain resource utilization configuration comprising information that indicates a mode of frequency-domain resource utilization for each of at least some of a plurality of frequency parts of an available bandwidth of the IAB node. The processing circuitry is further configured to cause the IAB node to determine a frequency-domain resource usage of MT of the IAB node and a DU of the IAB node based on the frequency-domain resource utilization configuration.

Embodiments of a method performed by a parent node of an IAB node are also disclosed. In one embodiment, a method performed by a parent node of an IAB node comprises receiving, from the IAB node, information about one or more desired guard bands of the IAB node, sending, to the IAB node, information about one or more provided guard bands for the IAB node, and explicitly indicating an availability of one or more soft resources to the IAB node.

Corresponding embodiments of a parent node of an IAB node are also disclosed. In one embodiment, a parent node of an IAB node is adapted to receive, from the IAB node, information about one or more desired guard bands of the IAB node, send, to the IAB node, information about one or more provided guard bands for the IAB node, and explicitly indicate an availability of one or more soft resources to the IAB node.

In one embodiment, a parent node of an IAB node comprises processing circuitry configured to cause the parent node to receive, from the IAB node, information about one or more desired guard bands of the IAB node, send, to the IAB node, information about one or more provided guard bands for the IAB node, and explicitly indicate an availability of one or more soft resources to the IAB node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an Integrated Access and Backhaul (IAB) deployment;

FIG. 2 illustrates various terminology in an IAB deployment;

FIG. 3 is a reference diagram for a two-hop chain of IAB nodes under an IAB-donor;

FIG. 4 illustrates two topologies for an IAB deployment;

FIG. 5 illustrates one example of a Third Generation Partnership Project (3GPP) Release 16 IAB Distributed Unit (DU) configuration;

FIG. 6 illustrates one example of the frequency-domain DU resource configuration;

FIG. 7 illustrates one example of a radio access network (RAN), which is also referred to herein as an IAB network, in which embodiments of the present disclosure may be implemented;

FIG. 8 is a flow chart that illustrates a method performed by a centralized network function unit (e.g., the IAB-donor-CU) responsible for semi-static frequency-domain resource utilization configuration of an IAB node, in accordance with an embodiment of the present disclosure;

FIG. 9A is a flow chart that illustrates a method performed by an IAB node in accordance with an embodiment of the present disclosure;

FIG. 9B illustrates details regarding one of the steps of the method of FIG. 9A, in accordance with an embodiment of the present disclosure;

FIGS. 10, 11, 12, and 13 illustrate examples of an actual usage determination procedure, in accordance with embodiments of the present disclosure;

FIG. 14 is a flow chart that illustrates a method performed by a parent node of an IAB node in accordance with an embodiment of the present disclosure;

FIGS. 15 and 16 are schematic block diagrams of example embodiments of an IAB node;

FIG. 17 illustrates another example of a system in which embodiments of the present disclosure may be implemented;

FIG. 18 illustrates example embodiments of the host computer, base station, and UE of FIG. 17; and

FIGS. 19, 20, 21, and 22 are flow charts that illustrate example methods performed in the system of FIG. 17.

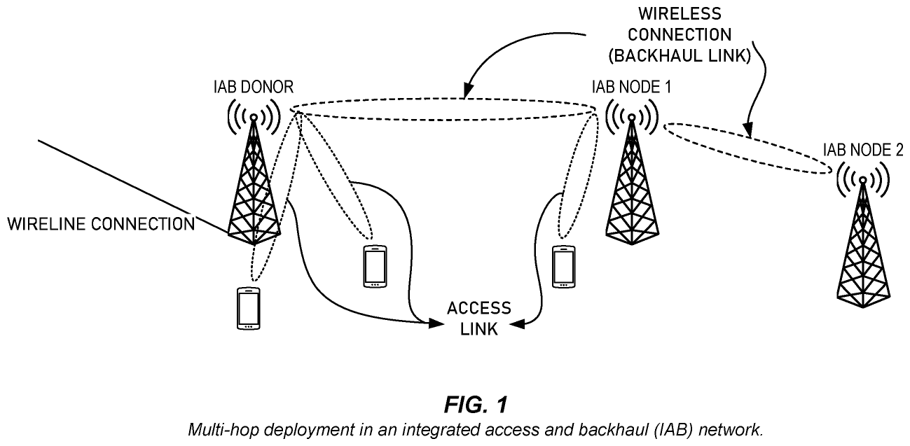

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

IAB Node: As used herein, an Integrated Access and Backhaul (IAB) node is a RAN node that supports wireless access to UEs and wirelessly backhauls the access traffic. According to 3GPP Technical Specification (TS) 38.300, V16.3.0, an IAB node is a RAN node that supports NR access links to UEs and NR backhaul links to parent nodes and child nodes.

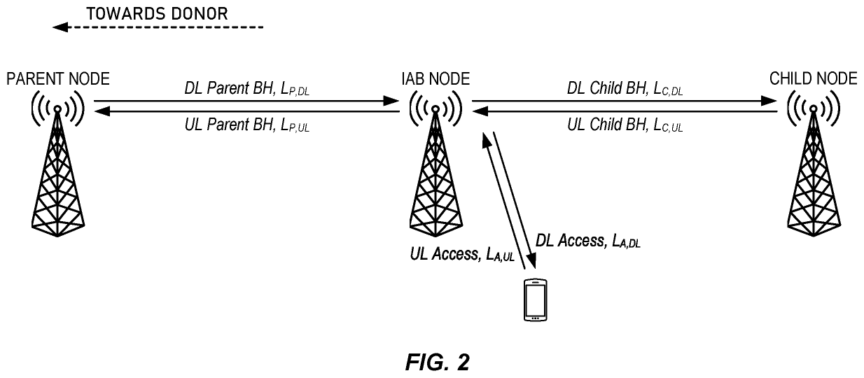

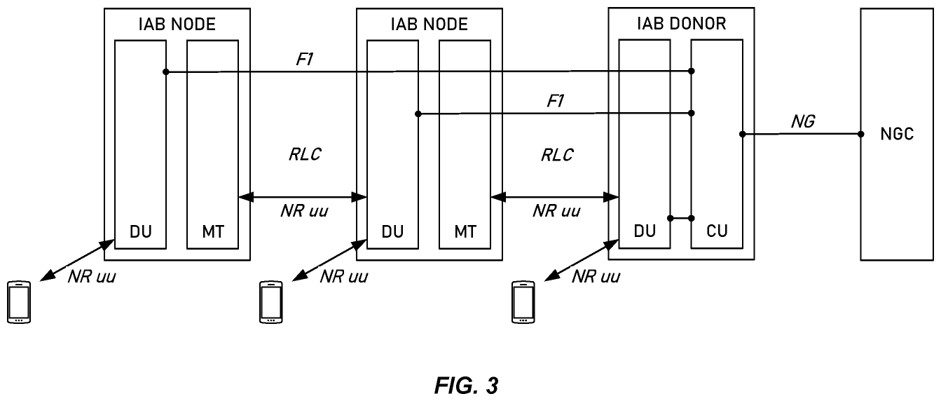

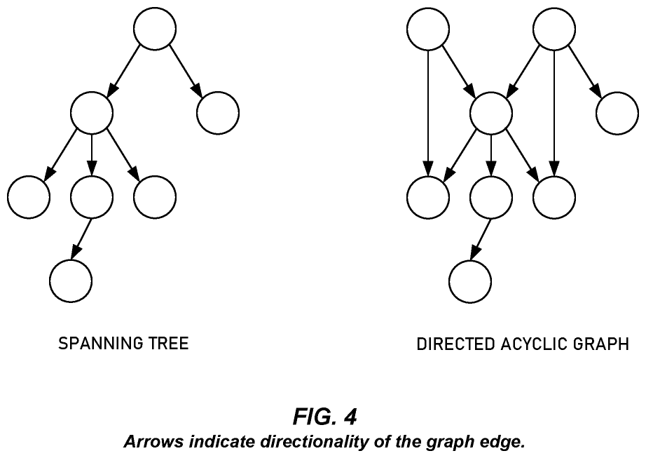

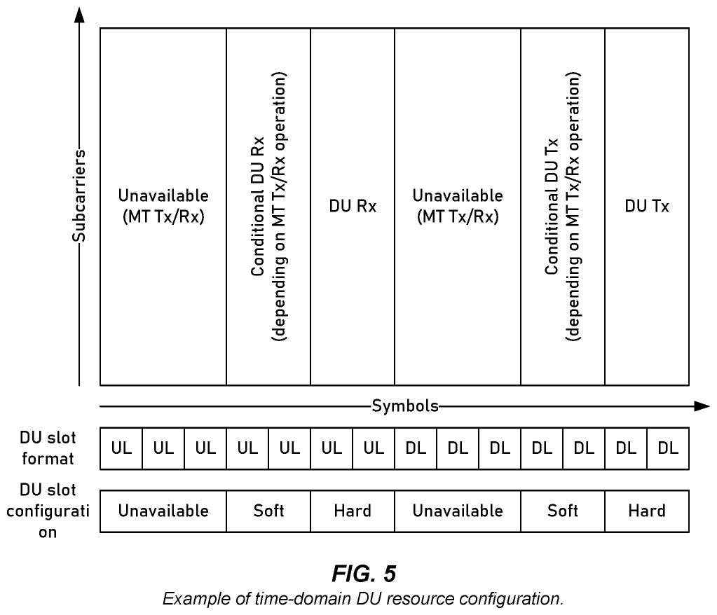

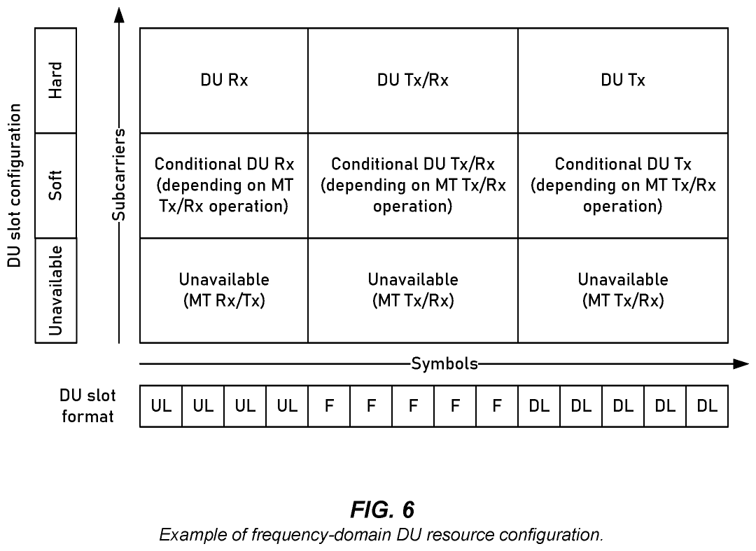

IAB Donor Node: As used herein, an IAB donor node is a node that connects to the core network. According to 3GPP TS 38.300, V16.3.0, an IAB Donor Node is a gNB that provides network access to UEs via a network of backhaul and access links. The IAB donor includes a Central Unit (CU). Note that an IAB donor node may also be an IAB node. For instance, a donor IAB node is a parent IAB node, i.e., the IAB donor node serves as an upstream node for an IAB node, as depicted in FIG. 2.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s) in regard to Integrated Access and Backhaul (IAB) networks in 3GPP. In Release 16, time-domain Hard (H)/Soft (S)/Not Available (NA) attributes are indicated per-resource type (Downlink (D)/Uplink (U)/Flexible (F)) in each slot. It has been envisioned in Release 17 IAB enhancement that configuring frequency-domain H/S/NA is advantageous to allow for greater flexibility, reduced cross-link interference (CLI), and reduced latency. However, how to indicate such frequency-domain resource utilization is not defined.

Certain aspects of the present disclosure and their embodiments may provide solutions to the aforementioned or other challenges. Embodiments of a method for a centralized network function unit (e.g., Central Unit (CU) of an IAB donor (i.e., an “IAB-donor-CU”) to indicate frequency-domain resource utilization in terms of H/S/NA to an IAB node are disclosed. Some embodiments also provide methods for an IAB node to treat the configured frequency-domain H/S/NA resources. Corresponding embodiments of a centralized network function unit and an IAB node are also disclosed.

There are, proposed herein, various embodiments which address one or more of the issues disclosed herein. In one embodiment, a method performed by a network node that implements a centralized network function unit for frequency-domain resource utilization configuration of an IAB node comprises one or more of the following: determining a configurable frequency part size(s) for a frequency-domain resource utilization configuration of an IAB node; determining a mode of frequency-domain resource utilization for each of at least some of a plurality of frequency parts of an available bandwidth of the IAB node, wherein the available bandwidth is divided into the plurality of frequency parts in accordance with the configurable frequency part size(s); and sending the frequency-domain resource utilization configuration to the IAB node, wherein the frequency-domain resource utilization configuration comprises information that indicates the mode of frequency-domain resource utilization for each of the at least some of the plurality of frequency parts of the available bandwidth of the IAB node.

In one embodiment, a method performed by an IAB node comprises one or more of the following: receiving a frequency-domain resource utilization configuration from a network node, wherein the frequency-domain resource utilization configuration comprises information that indicates a mode of frequency-domain resource utilization for each of at least some of a plurality of frequency parts of an available bandwidth of the IAB node, and determining a frequency-domain resource usage of an IAB-MT of the IAB node and an IAB-DU of the IAB node based on the frequency-domain resource utilization configuration.

In one embodiment, a method performed by a parent node of an IAB node comprises one or more of the following: receiving, from the IAB node, information about one or more desired guard bands of the IAB node, sending, to the IAB node, information about one or more provided guard bands for the IAB node, and explicitly indicating an availability of one or more soft resources to the IAB node.

Certain embodiments may provide one or more of the following technical advantage(s). Embodiments of the solution(s) disclosed herein may provide high flexibility for configuring frequency-domain resource utilization at an IAB node to enable efficient frequency multiplexing between a Mobile Termination (MT) of an IAB node (i.e., an “IAB-MT”) and a Distributed Unit (DU) of the IAB node (i.e., an “IAB-DU”). Meanwhile, the complexity of fulfilling such configuration is low. Embodiments disclosed herein are compatible to the frequency allocation scheme used by a network device (e.g., a UE) so that the configured resource utilization at an IAB-DU can be effectively used to communicate with both a child IAB node or a served UE.

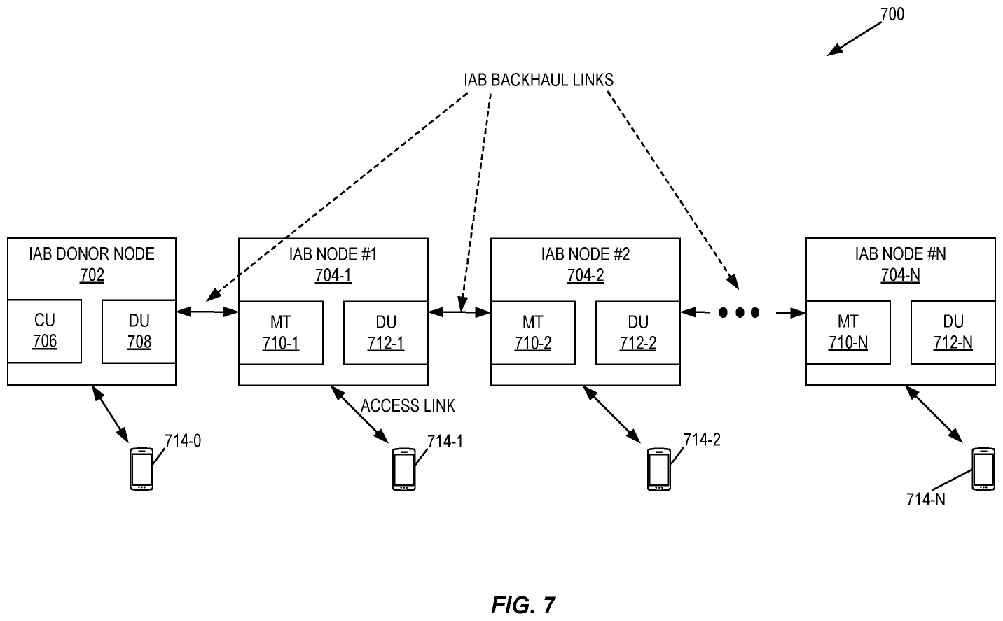

FIG. 7 illustrates one example of a radio access network (RAN) 700, which is also referred to herein as an IAB network, in which embodiments of the present disclosure may be implemented. In the embodiments described herein, the RAN 700 is a Next Generation RAN (NG-RAN), which is part of a 5G System (5GS) which includes the NG-RAN and a Fifth Generation Core (5GC), or an Evolved Universal Terrestrial Radio Access Network (E-UTRAN), which is part of an Evolved Packet System (EPS) which includes the E-UTRAN and an Evolved Packet Core (EPC). As will be appreciated by those of skill in the art, the RAN 700 includes an IAB donor node 702 and a number of IAB nodes 704-1 through 704-N. The IAB donor node 702 includes a Central Unit (CU) 706 (also referred to herein as IAB-donor-CU 706) and a Distributed Unit (DU) 708 (also referred to herein as IAB-donor-DU 708). The IAB donor node 702 preferably has a wired backhaul connection to the core network (not shown). The IAB nodes 704-1 through 704-N include respective Mobile Termination functions (MTs) 710-1 through 710-N (also referred to herein as IAB-MTs 710-1 through 710-N) and respective DUs 712-1 through 712-N (also referred to herein as IAB-DUs 712-1 through 712-N). The IAB nodes 704-1 through 704-N are generally referred to herein as IAB nodes 704. The IAB nodes 704 and optionally in this example the IAB donor node 702 provide radio access to respective wireless communication devices (WCDs) 714-0 through 714-N, which are generally referred to herein as WCDs 714. Note that only one WCD 714 is illustrated for each of the IAB donor node 702 and IAB nodes 704 for clarity, it should be appreciated that each of the IAB donor node 702 and IAB nodes 704 may provide radio access to many WCDs 714. Further, while not illustrated in FIG. 7, a single IAB node 704 may have multiple child nodes and/or multiple parent nodes.

Some or all of the IAB nodes 704 (and the IAB donor node 702) are, in the embodiments described herein, capable of frequency-domain multiplexing (FDM). For an IAB node 704 that is capable of FDM, the IAB-MT 710 and the IAB-DU 712 can use time-domain resources simultaneously but need coordination on the usage of frequency-domain resources. It has been proposed to configure an FDM-capable IAB node 704 with frequency-domain H/S/NA. This configuration provides the IAB-MT 710 and the IAB-DU 712 with different priorities regarding different frequency-domain resources, and thereby introduces higher scheduling flexibility to the IAB network. Systems and methods are disclosed herein that provide ways of indicating such a configuration and how the configured resource should be treated at the IAB node 704.

Typically, in NR, the frequency-domain resource is processed per resource block (RB). If frequency-domain H/S/NA is also indicated per RB, however, the complexity of both resource configuration at the IAB-donor-CU 706 and resource utilization at the IAB node 704 is high. Another issue is the compatibility to an access UE frequency-domain resource allocation as specified in 3GPP Technical Specification (TS) 38.214 (e.g., V16.3.0), clause 5.1.2.2 for DL and clause 6.1.2.2 for UL, the granularity of which is in resource block groups (RBGs). Given allocation type 0, for example, the minimum RBG size allocated for a UE is two RBs. If H/S/NA is indicated per RB, it is likely that a given RBG that should have been allocated to a UE has half configured as Hard and half configured as NA at the IAB-DU 712. As a result, the whole RBG cannot be used by the UE. This largely limits the frequency-domain resources available for access links. Such conflict should be avoided when indicating frequency-domain H/S/NA to an IAB-DU 712.

Another different aspect between time-domain and frequency-domain resources is the interference between adjacent resources. In the TDM case, if the IAB-DU 712 uses Slot 1 and the IAB-MT 710 uses Slot 2, there is no interference between the IAB-DU 712 and the IAB-MT 710. But in the FDM case, if the IAB-DU 712 uses frequency-resource 1 and the IAB-MT 710 uses frequency-resource 2 with frequency-resource 1 and frequency-resource 2 being next to each other, there might still be interference between the IAB-DU 712 and the IAB-MT 710. This issue should be considered when defining frequency-domain H/S in terms of the usage of certain resource at the IAB-DU/MT and the impact on the IAB-MT/DU.

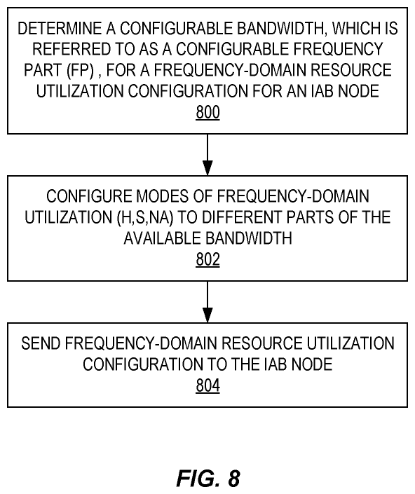

In one embodiment of the present disclosure, a centralized network function unit (e.g., the IAB-donor-CU 706) responsible for semi-static frequency-domain resource utilization configuration of an IAB node 704 performs the method as illustrated in FIG. 8. While in one embodiment the centralized network function unit is the IAB-donor-CU 706, the present disclosure is not limited thereto. The centralized network function unit may alternatively be implemented as or at a separate network node that is communicatively coupled (directly or indirectly) to the IAB node 704. As illustrated in FIG. 8, the centralized network function unit performs the following steps
Step 800: The centralized network function unit defines a configurable bandwidth (BW) referred to as a frequency part (FP). The configurable FP defines a resolution of the frequency-domain resource utilization configuration of the IAB node 704. In other words, the centralized network function determines a configurable frequency part size(s). In much of the following, it is assumed that there is a single configurable frequency part size. However, there may be more than one configured size (e.g., two or more different frequency part sizes for two or more different frequency parts or groups of frequency parts).
   In one embodiment, the configurable FP is further chosen such that the size of the configurable FP is a multiple of FP(s) used for communication between a network node and a network device. For example, in one particular embodiment, the size of the configurable FP is a multiple of the size of RBGs specified in TS 38.214, clause 5.1.2.2 for DL and clause 6.1.2.2 for UL.
   In one embodiment, the configurable FP is one or multiple consecutive RBs, which is also referred to as RBG.
   In one embodiment, the size of the configurable FP is based on information about a frequency-domain resource condition (e.g., interference condition (note that interference is dependent on power in FPs), transmit power in different FPs, or the like) between the IAB-MT 710 and the co-located IAB-DU 712 of the IAB node 704 for which the frequency-domain resource utilization configuration is being generated. This information may be received by the centralized network function unit from another network node, e.g., the IAB node 704 or the IAB donor node 702.
   In one embodiment, the size of the configurable FP is based on information about a desired size of the FP of the IAB node 704 for which the frequency-domain resource utilization configuration is being generated. The information about the desired size of the FP of the IAB node 704 may, for example, be received by the centralized network function unit from, e.g., the IAB node 704 or the IAB donor node 702.
Step 802: The centralized network function unit configures modes of frequency-domain resource utilization based on the configurable FP to different frequency parts of the available bandwidth. Any suitable criteria may be used to decide what mode of frequency-domain resource utilization of each frequency part may be used. Such criteria are not the focus of the present disclosure. Each frequency part of the available bandwidth has a bandwidth equal to the determined configurable FP from step 800. The available bandwidth is a total bandwidth of the frequency-domain resources that are available for the wireless link between the IAB node 704 and its parent node and/or its child node. For example, if the available bandwidth is 275 RBs and the configurable FP size is 6 RBs, then there are 46 frequency parts (46 frequency parts×6 RBs per frequency part=276 RBs, where one of the frequency parts would be understood to have only 5 RBs to arrive at the available bandwidth of 275 RBs). In one embodiment, the minimum frequency part size is 1 RBG, which is 2 RBs.
   For each of the different frequency parts of the available bandwidth, the mode of frequency-domain resource utilization is:
      Hard (H),
      Soft (S), or
      Not-Available (NA).
Step 804: The centralized network function unit sends the frequency-domain resource utilization configuration to the IAB node 704. The frequency-domain resource utilization configuration includes information that indicates the configured mode of frequency-domain resource utilization for each frequency part of the available bandwidth as determined in Step 802 and optionally the configurable FP size as determined in Step 800.

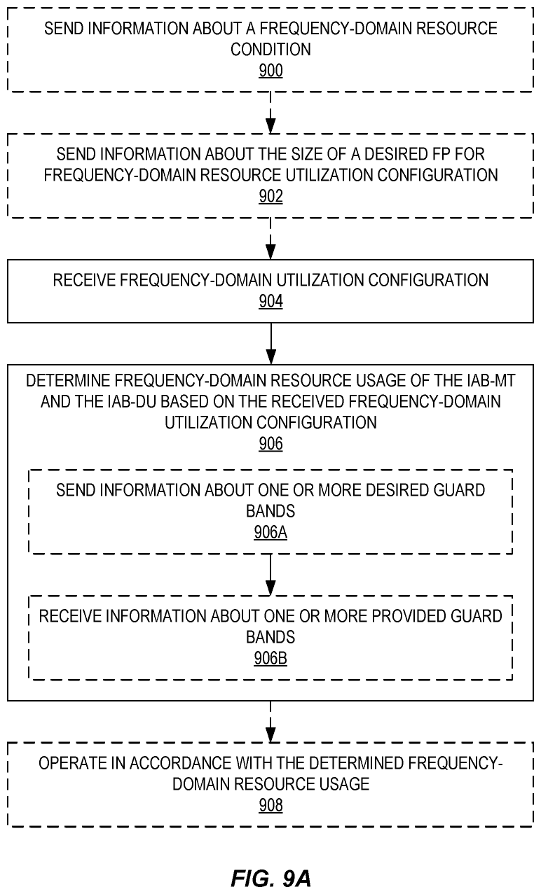

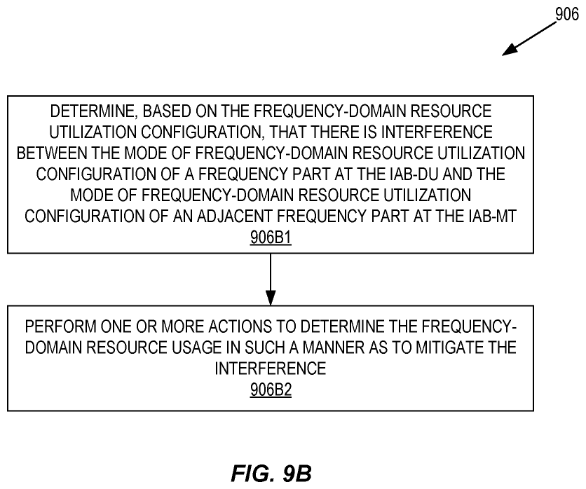

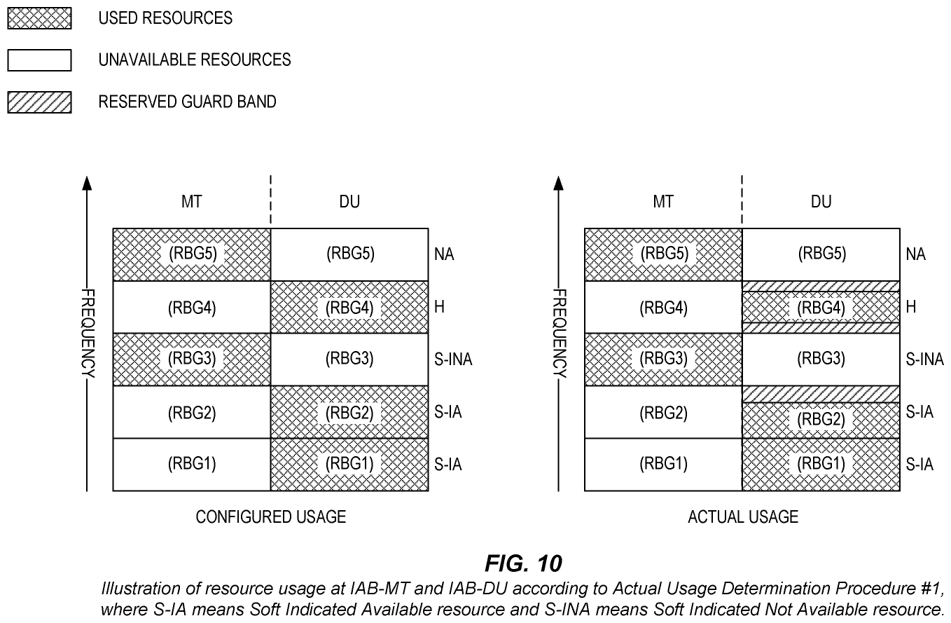

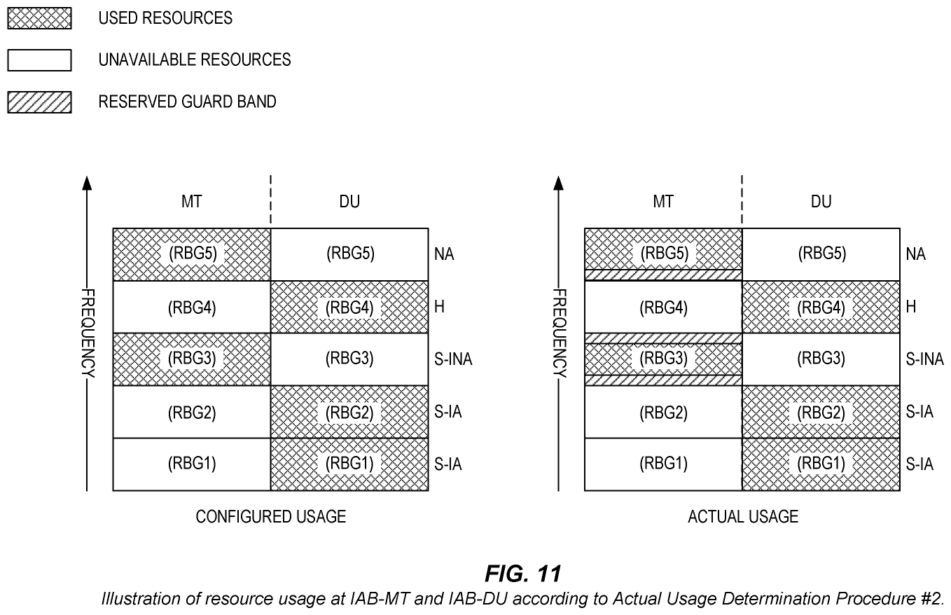

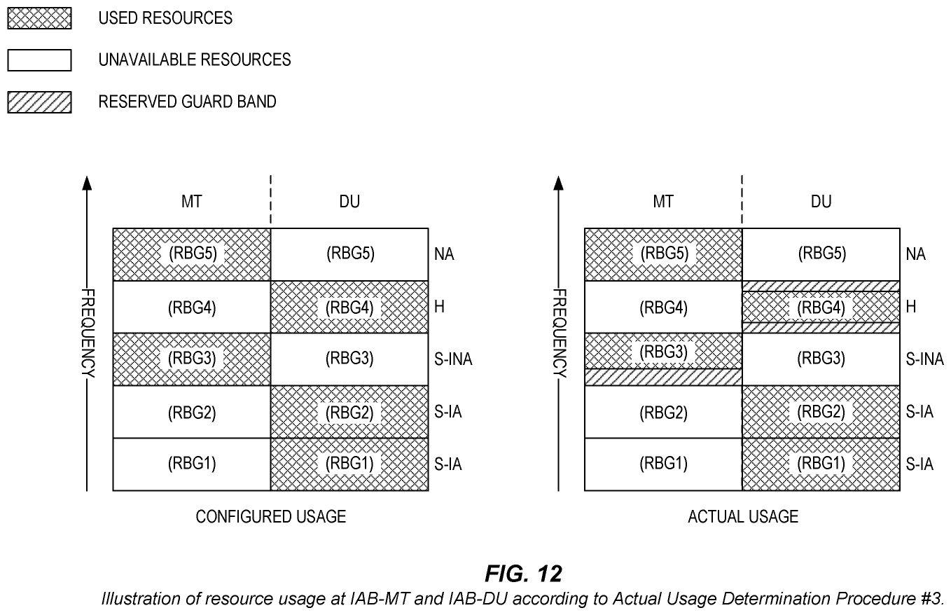

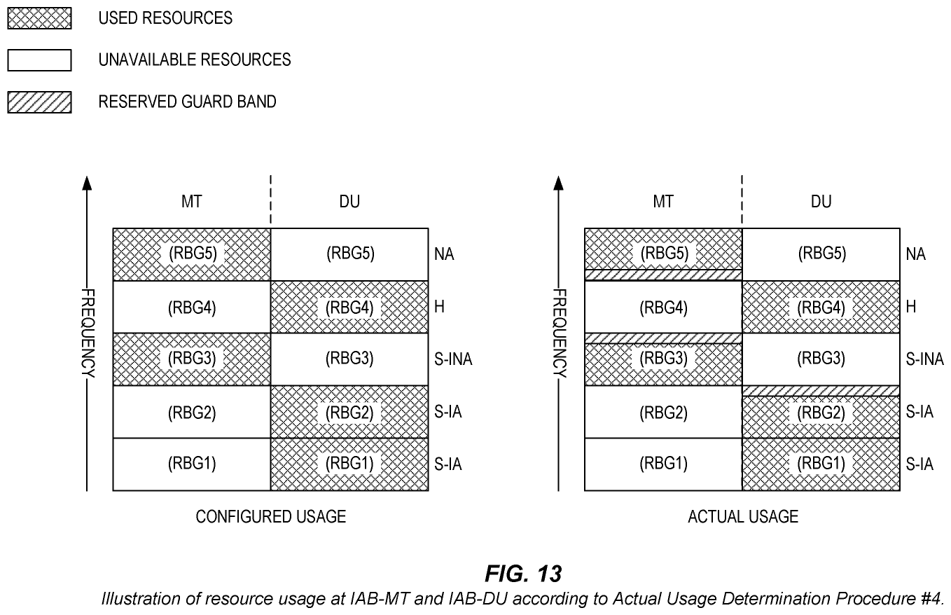

In one embodiment of the present disclosure, an IAB node 704 comprising an IAB-MT 710 and an IAB-DU 712 operates to perform the method illustrated in FIG. 9A. Optional steps are represented by dashed boxes in FIG. 9A. Note that while the functions or operations performed by the IAB node 704 are illustrated in FIG. 9A and described below as “steps”, these steps are not limited to being performed in the order illustrated in FIG. 9A. As illustrated, the IAB node 704 performs the following steps:
Step 900 (optional): The IAB node 704 sends information about the frequency-domain resource condition (e.g., interference condition) between the IAB-MT 710 and the IAB-DU 712 to its parent node(s) and/or the centralized network function unit.
Step 902 (optional): The IAB node 704 sends information about the size of a desired FP for frequency-domain resource utilization configuration to the centralized network function unit. In one embodiment, the IAB node 704 knows or determines the size of its desired FP, e.g., based on interference between adjacent FPs, capabilities of the IAB node 704 to sustain against or reduce interference, or the like.
Step 904: The IAB node 704 receives a frequency-domain resource utilization configuration (directly or indirectly via its parent node(s)) from the centralized network function unit. The frequency-domain resource utilization configuration indicates a mode of frequency-domain utilization (i.e., H/S/NA) for each of the multiple frequency parts of the available bandwidth.
   In one embodiment, if no specific frequency-domain resource utilization is configured for certain frequency part, then that frequency part is treated as a Soft resource.
Step 906: The IAB node 704 determines frequency-domain resource usage at the IAB-MT 710 and the IAB-DU 712 based on the received frequency-domain resource utilization configuration.
   As illustrated in FIG. 9B, in step 906, the IAB node 704 determines whether there is interference between one frequency part configured for H/S/NA at the IAB-DU 712 and the adjacent frequency part at the IAB-MT 710 (step 90661). If there is interference between one frequency part configured for H/S/NA at the IAB-DU 712 and the adjacent frequency part at the IAB-MT 710, the IAB node 704 performs one or more actions to determine the actual frequency-domain resource usage in such a manner as to mitigate this interference (step 90662). In one embodiment, the IAB node 704 performs one of the following interference mitigation procedures regarding H/S/NA:
      Actual Usage Determination Procedure #1: This procedure is exemplified in FIG. 10. One way to reduce or remove the impact on the ability of the IAB-MT 710 to transmit and receive in any other resource is for the IAB-DU 712 not to consider or use frequency resources that could have such MT impact when it determines resources for transmission (in DL) or reception (in UL). Such resources are likely closest to MT resources. In this procedure (as part of step 90662), the IAB node 704 operates as follows:
         For frequency-domain Hard resource: The IAB node 704 determines that the IAB-DU 712 can use the resource according to its configuration irrespective of the impact on the ability of the IAB-MT 710 to transmit or receive in the corresponding resource (i.e., the same FP) but only if it does not impact the ability of the IAB-MT 710 to transmit and receive in any other resource (i.e., other FPs) according to the configuration of that resource.
         For frequency-domain Soft resource: The IAB node 704 determines that the IAB-DU 712 can use the resource according to its configuration only if it does not impact the ability of the IAB-MT 710 to transmit and receive in any resource (i.e., both the same FP and other FPs) that is used by or for communication to the IAB-MT 710.
         If the Soft resource is indicated as available by the parent node, the IAB-DU 712 can use the resource according to its configuration but only if it does not impact the ability of the IAB-MT 710 to transmit and receive in any other resource (i.e., other FPs) according to the configuration of that resource.
         For frequency-domain NA resource: The IAB node 704 determines that the IAB-DU 712 cannot use the resource.
      Actual Usage Determination Procedure #2: This procedure is exemplified in FIG. 11. In this procedure (as part of step 90662), the IAB node 704 operates as follows:
         For frequency-domain Hard resource: The IAB node 704 determines that the IAB-DU 712 can use the resource according to its configuration irrespective of the impact on the IAB-MT's ability to transmit or receive in any resource (i.e., both the same FP and other FPs) that is used by or for communication to the IAB-MT 710. To determine the actual resource usage at the IAB-MT 710 and the IAB-DU 712, the IAB node 704 sends information to the parent node about one or multiple desired guard bands the parent node should reserve at the adjacent FPs of IAB-MT at the upper edge and/or lower edge of the IAB-DU configured FP.
         For frequency-domain Soft resource: The IAB node 704 determines that the IAB-DU 712 can use the resource according to its configuration only if it does not impact the ability of the IAB-MT 710 to transmit and receive in corresponding resource (i.e., the same FP).
         If the Soft resource is indicated as available by the parent node, the IAB-DU 712 can use the resource according to its configuration irrespective of the impact on the ability of the IAB-MT 710 to transmit or receive in any other resource (i.e., other FPs). To determine the actual resource usage at the IAB-MT 710 and the IAB-DU 712, the IAB node 704 sends information to the parent node about one or multiple desired guard bands the parent node should reserve at the adjacent FPs of IAB-MT at the upper edge and/or lower edge of the IAB-DU configured FP.
         For frequency-domain NA resource: The IAB node 704 determines that the IAB-DU 712 cannot use the resource.
      Actual Usage Determination Procedure #3: This procedure is exemplified in FIG. 12. In this procedure (as part of step 90662), the IAB node 704 operates as follows:
         For frequency-domain Hard resource: The IAB node 704 determines that the IAB-DU 712 can use the resource according to its configuration irrespective of the impact on the ability of the IAB-MT 710 to transmit or receive in the corresponding resource (i.e., the same FP) but only if it does not impact the ability of the IAB-MT 710 to transmit and receive in any other resource (i.e., other FPs) according to the configuration of that resource. To determine the actual resource usage at the IAB-MT 710 and the IAB-DU 712, the IAB node 704 sends information to the parent node about one or multiple desired guard bands the IAB node would reserve at the upper edge and/or lower edge of the IAB-DU configured FP. No need to inform guard bands at IAB-DU.
         For frequency-domain Soft resource: The IAB node 704 determines that the IAB-DU 712 can use the resource according to its configuration only if it does not impact the ability of the IAB-MT 710 to transmit and receive in corresponding resource (i.e., the same FP).
         If the Soft resource is indicated as available by the parent node, IAB-DU 712 can use the resource according to its configuration irrespective of the impact on the ability of the IAB-MT 710 to transmit or receive in any other resource (i.e., other FPs). To determine the actual resource usage at the IAB-MT 710 and the IAB-DU 712, the IAB node 704 sends information to the parent node about one or multiple desired guard bands the parent node should reserve at the adjacent FPs of IAB-MT at the upper edge and/or lower edge of the IAB-DU configured FP.
         For frequency-domain NA resource: The IAB node 704 determines that the IAB-DU 712 cannot use the resource.
      Actual Usage Determination Procedure #4: This procedure is exemplified in FIG. 13. In this procedure (as part of step 90662), the IAB node 704 operates as follows:
         For frequency-domain Hard resource: The IAB node 704 determines that the IAB-DU 712 can use the resource according to its configuration irrespective of the impact on the ability of the IAB-MT 710 to transmit or receive in any resource (i.e., both the same FP and other FPs) that is used by or for communication to the IAB-MT 710. To determine the actual resource usage at the IAB-MT 710 and the IAB-DU 712, the IAB node 704 sends information to the parent node about one or multiple desired guard bands the parent node should reserve at the adjacent FPs of IAB-MT at the upper edge and/or lower edge of the IAB-DU configured FP.
         For frequency-domain Soft resource: The IAB node 704 determines that the IAB-DU 712 can use the resource according to its configuration only if it does not impact the ability of the IAB-MT 710 to transmit and receive in any resource (i.e., both the same FP and other FPs) that is used by or for communication to the IAB-MT 710.
         If the Soft resource is indicated as available by the parent node, the IAB-DU 712 can use the resource according to its configuration but only if it does not impact the ability of the IAB-MT 710 to transmit and receive in any other resource (i.e., other FPs) according to the configuration of that resource. To determine the actual resource usage at the IAB-MT 710 and the IAB-DU 712, the IAB node 704 sends information to the parent node about one or multiple desired guard bands the IAB node would reserve at the upper edge and/or lower edge of the IAB-DU configured FP. No need to inform guard band at the IAB-DU.
         For frequency-domain NA resource: The IAB node 704 determines that the IAB-DU 712 cannot use the resource.
      If Actual Usage Determination Procedure #2, #3, or #4 is used to determine the actual resource usage at the IAB-MT 710 and the IAB-DU 712, the IAB node 704 sends information about one or multiple desired guard bands (e.g., desired number of subcarriers to be reserved by the adjacent FPs of the IAB-MT 710 at the upper edge and/or lower edge of an IAB-DU configured FP) to the parent node of the IAB node 704. The parent node may respond with one or multiple provided guard bands accordingly. The information about the desired/provided guard band(s) (i.e., the guard band information) can be required width (i.e., the width of the guard bands in the frequency-domain) and optionally information about where to apply the guard band(s). Without information about where to apply the guard band(s), it could be interpreted as everywhere where IAB-MT resources and resources available to IAB-DU are adjacent. In this regard, in step 906, the one or more actions performed by the IAB node 704 may include sending information about one or more desired guard bands to its parent node(s) (step 906A1) and receiving information about one or more provided guard band(s) from the parent node(s) (step 906A2), where the determined frequency-domain resource usage is based on the received frequency-domain resource utilization configuration and the received information about the one or more provided guard bands.
Step 908 (optional): The IAB node 704 operates in accordance with the determined frequency-domain resource usage.

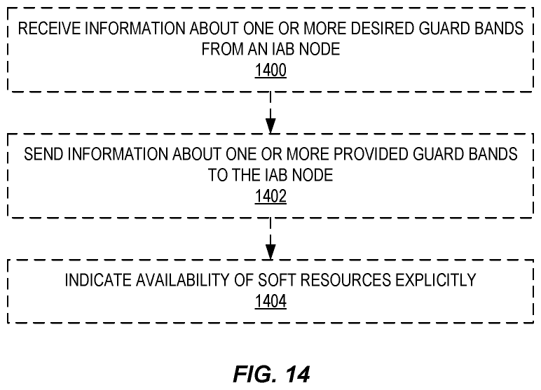

In one embodiment of the present disclosure, a parent-node comprising a parent IAB-MT and a parent IAB-DU operates in accordance with the method of FIG. 14. The parent node may be, for example, the parent node of IAB node 704-2, which is IAB node 704-1. In this example, the parent node is the IAB node 704-1. Note that optional steps are represented by dashed boxes. Note that while the functions or operations performed by the parent node are illustrated in FIG. 14 and described below as “steps”, these steps are not limited to being performed in the order illustrated in FIG. 14. As illustrated, the parent node performs the following steps:
Step 1400 (optional): The parent node may receive, from the IAB node 704, information about one or multiple desired guard bands (e.g., desired number of subcarriers to be reserved by the adjacent FPs of IAB-MT 710 at the upper edge and/or lower edge of an IAB-DU configured FP).
Step 1402 (optional): The parent node may respond with information about one or multiple provided guard bands accordingly.
Step 1404 (optional): The parent node can indicate the availability of the soft frequency resource explicitly.

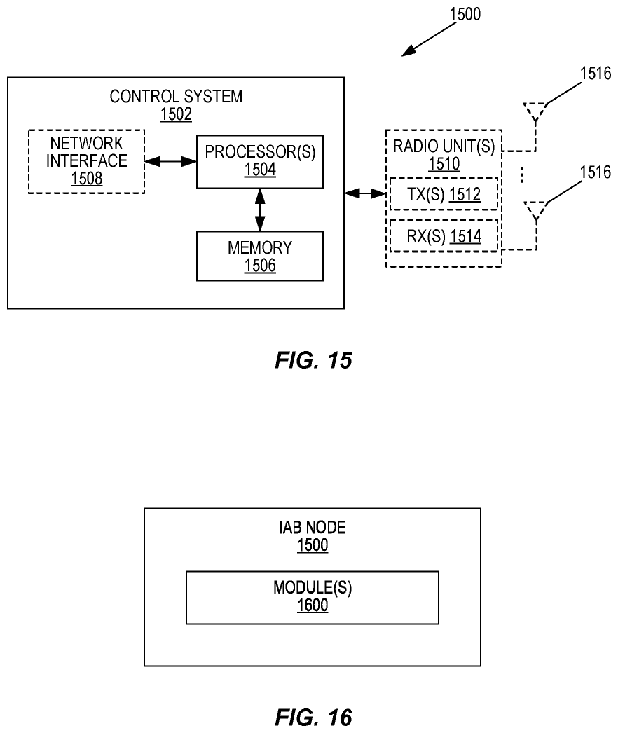

FIG. 15 is a schematic block diagram of a network node 1500 according to some embodiments of the present disclosure. Optional features are represented by dashed boxes. The network node 1500 may be, for example, a network node that implements the centralized network function unit, the IAB donor node 702, or one of the IAB nodes 704 as described herein. As illustrated, the network node 1500 includes a control system 1502 that includes one or more processors 1504 (e.g., Central Processing Units (CPUs), Application Specific Integrated Circuits (ASICs), Field Programmable Gate Arrays (FPGAs), and/or the like), memory 1506, and optionally a network interface 1508. The one or more processors 1504 are also referred to herein as processing circuitry. In addition, the network node 1500 includes one or more radio units 1510 that each includes one or more transmitters 1512 and one or more receivers 1514 coupled to one or more antennas 1516. The radio units 1510 may be referred to or be part of radio interface circuitry. In some embodiments, the radio unit(s) 1510 is external to the control system 1502 and connected to the control system 1502 via, e.g., a wired connection (e.g., an optical cable). However, in some other embodiments, the radio unit(s) 1510 and potentially the antenna(s) 1516 are integrated together with the control system 1502. The one or more processors 1504 operate to provide one or more functions of the network node 1500 as described herein (e.g., one or more functions of the centralized network function unit, one or more functions of the IAB donor node 702, one or more functions of the IAB node 704, or one or more functions of a parent node as described above, e.g., with respect to FIGS. 8-13). In some embodiments, the function(s) are implemented in software that is stored, e.g., in the memory 1506 and executed by the one or more processors 1504.

FIG. 16 is a schematic block diagram of the network node 1500 according to some other embodiments of the present disclosure. The network node 1500 includes one or more modules 1600, each of which is implemented in software. The module(s) 1600 provide the functionality of the network node 1500 described herein (e.g., one or more functions of the centralized network function unit, one or more functions of the IAB donor node 702, one or more functions of the IAB node 704, or one or more functions of a parent node as described above, e.g., with respect to FIGS. 8-13).

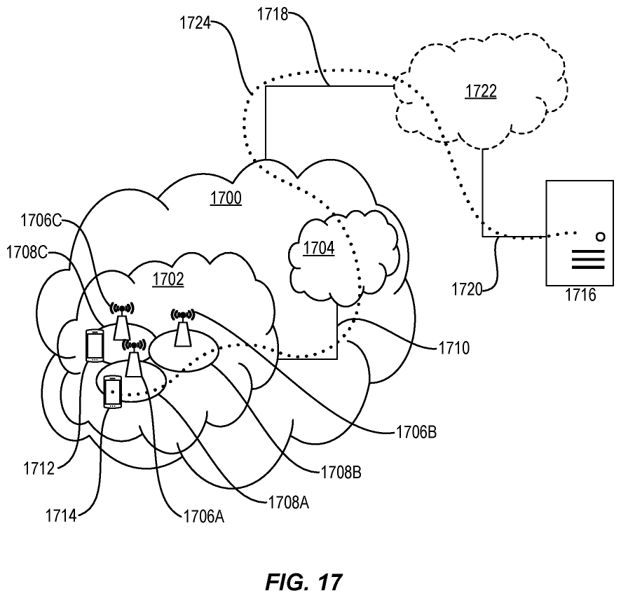

With reference to FIG. 17, in accordance with an embodiment, a communication system includes a telecommunication network 1700, such as a 3GPP-type cellular network, which comprises an access network 1702, such as a RAN, and a core network 1704. The access network 1702 comprises a plurality of base stations 1706A, 1706B, 1706C, such as Node Bs, eNBs, gNBs, or other types of wireless Access Points (APs), each defining a corresponding coverage area 1708A, 1708B, 1708C. Each base station 1706A, 1706B, 1706C is connectable to the core network 1704 over a wired or wireless connection 1710. A first UE 1712 located in coverage area 1708C is configured to wirelessly connect to, or be paged by, the corresponding base station 1706C. A second UE 1714 in coverage area 1708A is wirelessly connectable to the corresponding base station 1706A. While a plurality of UEs 1712, 1714 are illustrated in this example, the disclosed embodiments are equally applicable to a situation where a sole UE is in the coverage area or where a sole UE is connecting to the corresponding base station 1706.

The telecommunication network 1700 is itself connected to a host computer 1716, which may be embodied in the hardware and/or software of a standalone server, a cloud-implemented server, a distributed server, or as processing resources in a server farm. The host computer 1716 may be under the ownership or control of a service provider, or may be operated by the service provider or on behalf of the service provider. Connections 1718 and 1720 between the telecommunication network 1700 and the host computer 1716 may extend directly from the core network 1704 to the host computer 1716 or may go via an optional intermediate network 1722. The intermediate network 1722 may be one of, or a combination of more than one of, a public, private, or hosted network; the intermediate network 1722, if any, may be a backbone network or the Internet; in particular, the intermediate network 1722 may comprise two or more sub-networks (not shown).

The communication system of FIG. 17 as a whole enables connectivity between the connected UEs 1712, 1714 and the host computer 1716. The connectivity may be described as an Over-the-Top (OTT) connection 1724. The host computer 1716 and the connected UEs 1712, 1714 are configured to communicate data and/or signaling via the OTT connection 1724, using the access network 1702, the core network 1704, any intermediate network 1722, and possible further infrastructure (not shown) as intermediaries. The OTT connection 1724 may be transparent in the sense that the participating communication devices through which the OTT connection 1724 passes are unaware of routing of uplink and downlink communications. For example, the base station 1706 may not or need not be informed about the past routing of an incoming downlink communication with data originating from the host computer 1716 to be forwarded (e.g., handed over) to a connected UE 1712. Similarly, the base station 1706 need not be aware of the future routing of an outgoing uplink communication originating from the UE 1712 towards the host computer 1716.

Example implementations, in accordance with an embodiment, of the UE, base station, and host computer discussed in the preceding paragraphs will now be described with reference to FIG. 18. In a communication system 1800, a host computer 1802 comprises hardware 1804 including a communication interface 1806 configured to set up and maintain a wired or wireless connection with an interface of a different communication device of the communication system 1800. The host computer 1802 further comprises processing circuitry 1808, which may have storage and/or processing capabilities. In particular, the processing circuitry 1808 may comprise one or more programmable processors, ASICs, FPGAs, or combinations of these (not shown) adapted to execute instructions. The host computer 1802 further comprises software 1810, which is stored in or accessible by the host computer 1802 and executable by the processing circuitry 1808. The software 1810 includes a host application 1812. The host application 1812 may be operable to provide a service to a remote user, such as a UE 1814 connecting via an OTT connection 1816 terminating at the UE 1814 and the host computer 1802. In providing the service to the remote user, the host application 1812 may provide user data which is transmitted using the OTT connection 1816.

The communication system 1800 further includes a base station 1818 provided in a telecommunication system and comprising hardware 1820 enabling it to communicate with the host computer 1802 and with the UE 1814. The hardware 1820 may include a communication interface 1822 for setting up and maintaining a wired or wireless connection with an interface of a different communication device of the communication system 1800, as well as a radio interface 1824 for setting up and maintaining at least a wireless connection 1826 with the UE 1814 located in a coverage area (not shown in FIG. 18) served by the base station 1818. The communication interface 1822 may be configured to facilitate a connection 1828 to the host computer 1802. The connection 1828 may be direct or it may pass through a core network (not shown in FIG. 18) of the telecommunication system and/or through one or more intermediate networks outside the telecommunication system. In the embodiment shown, the hardware 1820 of the base station 1818 further includes processing circuitry 1830, which may comprise one or more programmable processors, ASICs, FPGAs, or combinations of these (not shown) adapted to execute instructions. The base station 1818 further has software 1832 stored internally or accessible via an external connection.

The communication system 1800 further includes the UE 1814 already referred to. The UE's 1814 hardware 1834 may include a radio interface 1836 configured to set up and maintain a wireless connection 1826 with a base station serving a coverage area in which the UE 1814 is currently located. The hardware 1834 of the UE 1814 further includes processing circuitry 1838, which may comprise one or more programmable processors, ASICs, FPGAs, or combinations of these (not shown) adapted to execute instructions. The UE 1814 further comprises software 1840, which is stored in or accessible by the UE 1814 and executable by the processing circuitry 1838. The software 1840 includes a client application 1842. The client application 1842 may be operable to provide a service to a human or non-human user via the UE 1814, with the support of the host computer 1802. In the host computer 1802, the executing host application 1812 may communicate with the executing client application 1842 via the OTT connection 1816 terminating at the UE 1814 and the host computer 1802. In providing the service to the user, the client application 1842 may receive request data from the host application 1812 and provide user data in response to the request data. The OTT connection 1816 may transfer both the request data and the user data. The client application 1842 may interact with the user to generate the user data that it provides.

It is noted that the host computer 1802, the base station 1818, and the UE 1814 illustrated in FIG. 18 may be similar or identical to the host computer 1716, one of the base stations 1706A, 1706B, 1706C, and one of the UEs 1712, 1714 of FIG. 17, respectively. This is to say, the inner workings of these entities may be as shown in FIG. 18 and independently, the surrounding network topology may be that of FIG. 17.

In FIG. 18, the OTT connection 1816 has been drawn abstractly to illustrate the communication between the host computer 1802 and the UE 1814 via the base station 1818 without explicit reference to any intermediary devices and the precise routing of messages via these devices. The network infrastructure may determine the routing, which may be configured to hide from the UE 1814 or from the service provider operating the host computer 1802, or both. While the OTT connection 1816 is active, the network infrastructure may further take decisions by which it dynamically changes the routing (e.g., on the basis of load balancing consideration or reconfiguration of the network).

The wireless connection 1826 between the UE 1814 and the base station 1818 is in accordance with the teachings of the embodiments described throughout this disclosure. One or more of the various embodiments improve the performance of OTT services provided to the UE 1814 using the OTT connection 1816, in which the wireless connection 1826 forms the last segment. More precisely, the teachings of these embodiments may improve, e.g., latency and thereby provide benefits such as, e.g., reduced user waiting time and better responsiveness.

A measurement procedure may be provided for the purpose of monitoring data rate, latency, and other factors on which the one or more embodiments improve. There may further be an optional network functionality for reconfiguring the OTT connection 1816 between the host computer 1802 and the UE 1814, in response to variations in the measurement results. The measurement procedure and/or the network functionality for reconfiguring the OTT connection 1816 may be implemented in the software 1810 and the hardware 1804 of the host computer 1802 or in the software 1840 and the hardware 1834 of the UE 1814, or both. In some embodiments, sensors (not shown) may be deployed in or in association with communication devices through which the OTT connection 1816 passes; the sensors may participate in the measurement procedure by supplying values of the monitored quantities exemplified above, or supplying values of other physical quantities from which the software 1810, 1840 may compute or estimate the monitored quantities. The reconfiguring of the OTT connection 1816 may include message format, retransmission settings, preferred routing, etc.; the reconfiguring need not affect the base station 1818, and it may be unknown or imperceptible to the base station 1818. Such procedures and functionalities may be known and practiced in the art. In certain embodiments, measurements may involve proprietary UE signaling facilitating the host computer 1802's measurements of throughput, propagation times, latency, and the like. The measurements may be implemented in that the software 1810 and 1840 causes messages to be transmitted, in particular empty or ‘dummy’ messages, using the OTT connection 1816 while it monitors propagation times, errors, etc.

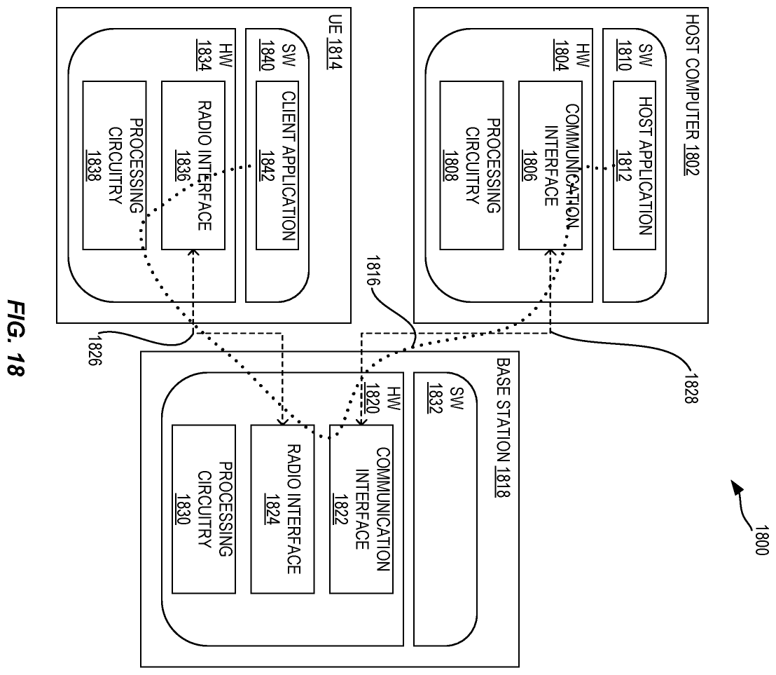

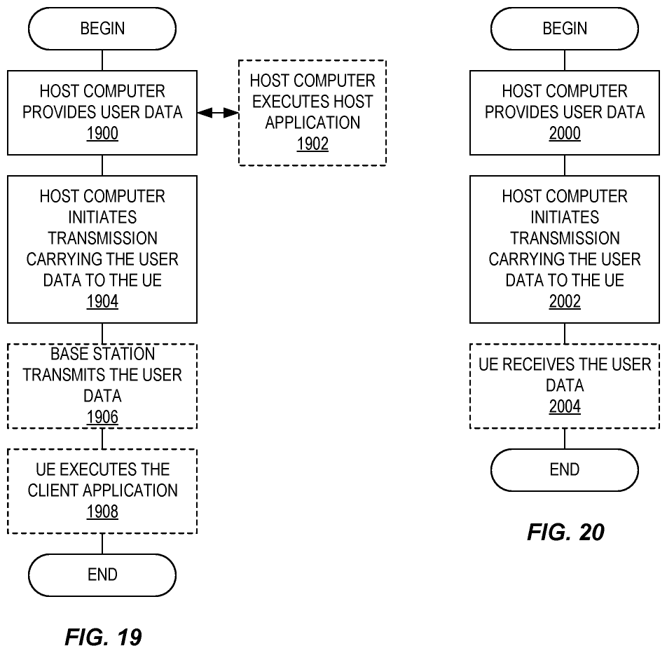

FIG. 19 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 19 will be included in this section. In step 1900, the host computer provides user data. In sub-step 1902 (which may be optional) of step 1900, the host computer provides the user data by executing a host application. In step 1904, the host computer initiates a transmission carrying the user data to the UE. In step 1906 (which may be optional), the base station transmits to the UE the user data which was carried in the transmission that the host computer initiated, in accordance with the teachings of the embodiments described throughout this disclosure. In step 1908 (which may also be optional), the UE executes a client application associated with the host application executed by the host computer.

FIG. 20 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 20 will be included in this section. In step 2000 of the method, the host computer provides user data. In an optional sub-step (not shown) the host computer provides the user data by executing a host application. In step 2002, the host computer initiates a transmission carrying the user data to the UE. The transmission may pass via the base station, in accordance with the teachings of the embodiments described throughout this disclosure. In step 2004 (which may be optional), the UE receives the user data carried in the transmission.

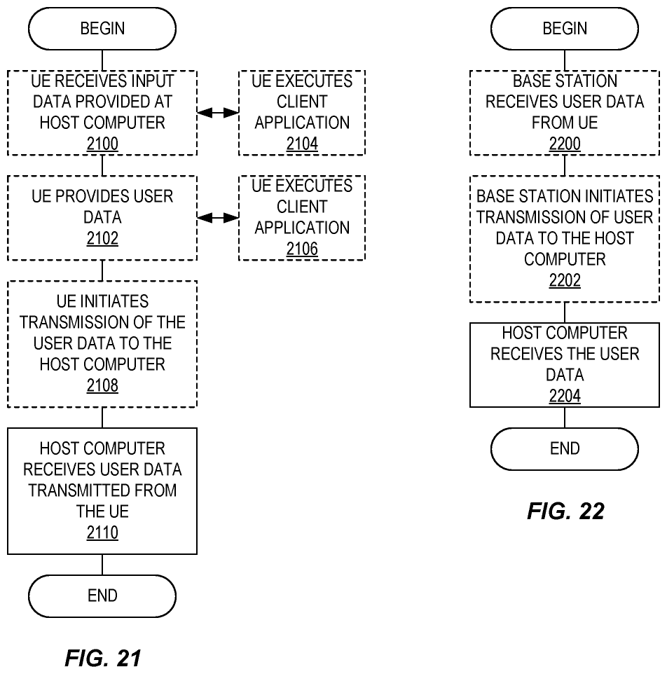

FIG. 21 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 21 will be included in this section. In step 2100 (which may be optional), the UE receives input data provided by the host computer. Additionally or alternatively, in step 2102, the UE provides user data. In sub-step 2104 (which may be optional) of step 2100, the UE provides the user data by executing a client application. In sub-step 2106 (which may be optional) of step 2102, the UE executes a client application which provides the user data in reaction to the received input data provided by the host computer. In providing the user data, the executed client application may further consider user input received from the user. Regardless of the specific manner in which the user data was provided, the UE initiates, in sub-step 2108 (which may be optional), transmission of the user data to the host computer. In step 2110 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station, and a UE which may be those described with reference to FIGS. 17 and 18. For simplicity of the present disclosure, only drawing references to FIG. 22 will be included in this section. In step 2200 (which may be optional), in accordance with the teachings of the embodiments described throughout this disclosure, the base station receives user data from the UE. In step 2202 (which may be optional), the base station initiates transmission of the received user data to the host computer. In step 2204 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a network node that implements a centralized network function unit for frequency-domain resource utilization configuration of an Integrated Access and Backhaul (IAB) node, the method comprising:
determining a configurable frequency part size(s) for a frequency-domain resource utilization configuration of an IAB node;
determining a mode of frequency-domain resource utilization for each of at least some of a plurality of frequency parts of an available bandwidth of the IAB node, the available bandwidth being divided into the plurality of frequency parts in accordance with the configurable frequency part size(s); and
sending the frequency-domain resource utilization configuration to the IAB node, the frequency-domain resource utilization configuration comprising information that indicates the mode of frequency-domain resource utilization for each of the at least some of the plurality of frequency parts of the available bandwidth of the IAB node.

2. The method of claim 1 wherein the frequency-domain resource utilization configuration of the IAB node comprises one or more of a frequency-domain resource utilization configuration for a Distributed Unit (DU) of the IAB node, a frequency-domain resource utilization configuration for a Mobile Termination (MT) of the IAB node, or a frequency-domain resource utilization configuration for an access link between the IAB node and a User Equipment (UE).

3. The method of claim 1 wherein determining the mode of frequency-domain resource utilization for each of the at least some of the plurality of frequency parts of the available bandwidth of the IAB node comprises determining the mode of frequency-domain resource utilization for each of the plurality of frequency parts of the available bandwidth of the IAB node, and the frequency-domain resource utilization configuration comprises information that indicates the mode of frequency-domain resource utilization for each of the plurality of frequency parts of the available bandwidth of the IAB node.

4. The method of claim 1 wherein, for each frequency part of the at least some of the plurality of frequency parts of the available bandwidth of the IAB node, the mode of frequency-domain resource utilization for the frequency part is either Hard, Soft, or Not Available.

5. The method of claim 1 wherein determining the configurable frequency part size for the frequency-domain resource utilization configuration of the IAB node comprises determining the configurable frequency part size for the frequency-domain resource utilization configuration of the IAB node such that the configurable frequency part size is a multiple of a size of a frequency part used for communication among the network node, a parent IAB node of the IAB node, a Termination unit (MT) of the IAB node, a child IAB node of the IAB node, and/or a wireless communication device in a respective cellular communications system.

6. The method of claim 1 wherein determining the configurable frequency part size for the frequency-domain resource utilization configuration of the IAB node comprises determining the configurable frequency part size for the frequency-domain resource utilization configuration of the IAB node such that the configurable frequency part size is a multiple of a size of a resource block group (RBG).

7. The method of claim 1 wherein determining the configurable frequency part size for the frequency-domain resource utilization configuration of the IAB node comprises determining the configurable frequency part size for the frequency-domain resource utilization configuration of the IAB node such that the configurable frequency part size is one or more consecutive resource blocks in the frequency-domain.

8. The method of claim 1 wherein determining the configurable frequency part size for the frequency-domain resource utilization configuration of the IAB node comprises determining the configurable frequency part size for the frequency-domain resource utilization configuration of the IAB node based on information about a frequency-domain resource condition between an IAB Mobile Termination unit (MT) of the IAB node and an IAB Distributed Unit (DU) of the IAB node.

9. The method of claim 8, wherein the MT of the IAB node establishes a communication interface or channel towards a parent IAB node and the DU of the IAB node establishes a communication interface or channel to a wireless communication device and/or establishes a communication interface or channel to the MT of a child IAB node.

10. The method of claim 1 wherein determining the configurable frequency part size for the frequency-domain resource utilization configuration of the IAB node comprises determining the configurable frequency part size for the frequency-domain resource utilization configuration of the IAB node based on information about a desired configurable frequency part size of the IAB node.

11-12. (canceled)

13. A network node that implements a centralized network function unit for frequency-domain resource utilization configuration of an Integrated Access and Backhaul (IAB) node, the network node comprising processing circuitry configured to cause the network node to:
determine a configurable frequency part size(s) for a frequency-domain resource utilization configuration of an IAB node;
determine a mode of frequency-domain resource utilization for each of at least some of a plurality of frequency parts of an available bandwidth of the IAB node, the available bandwidth being divided into the plurality of frequency parts in accordance with the configurable frequency part size(s); and
send the frequency-domain resource utilization configuration to the IAB node, the frequency-domain resource utilization configuration comprising information that indicates the mode of frequency-domain resource utilization for each of the at least some of the plurality of frequency parts of the available bandwidth of the IAB node.

14. (canceled)

15. A method performed by an Integrated Access and Backhaul (IAB) node, the method comprising:
receiving a frequency-domain resource utilization configuration from a network node, the frequency-domain resource utilization configuration comprising information that indicates a mode of frequency-domain resource utilization for each of at least some of a plurality of frequency parts of an available bandwidth of the IAB node; and
determining a frequency-domain resource usage of an IAB Mobile Termination unit (IAB-MT) of the IAB node and an IAB Distributed Unit (IAB-DU) of the IAB node (704) based on the frequency-domain resource utilization configuration.

16. The method of claim 15, wherein the IAB-MT of the IAB node establishes a communication interface or channel towards a parent IAB node, and the IAB-DU of the IAB node establishes a communication interface or channel to a wireless communication device and/or establishes a communication interface or channel to a MT of a child IAB node.

17. The method of claim 15 further comprising operating in accordance with the determined frequency-domain resource usage.

18. The method of claim 15 wherein, for each frequency part of the at least some of the plurality of frequency parts of the available bandwidth of the IAB node, the mode of frequency-domain resource utilization for the frequency part is either Hard, Soft, or Not Available.

19. The method of claim 15 wherein the frequency-domain resource utilization configuration comprises information that indicates the mode of frequency-domain resource utilization for each of the plurality of frequency parts of the available bandwidth of the IAB node.

20. (canceled)

21. The method of claim 15 wherein a size of the plurality of frequency parts is a multiple of a size of a frequency part used for communication among the network node, a parent IAB node of the IAB node, the IAB-MT of the IAB node, a child IAB node of the IAB node and/or a wireless communication device in a respective cellular communications system.

22-27. (canceled)

28. The method of claim 15 wherein determining the frequency-domain resource usage of the IAB-MT of the IAB node and the IAB-DU of the IAB node comprises:
determining, based on the frequency-domain resource utilization configuration, that there is interference between the mode of frequency-domain resource utilization configuration of a frequency part at the IAB-DU and the mode of frequency-domain resource utilization configuration of an adjacent frequency part at the IAB-MT, and responsive thereto:
performing one or more actions to determine the frequency-domain resource usage in such a manner as to mitigate the interference.

29. The method of claim 28 wherein, for a frequency part that is indicated by the frequency-domain resource utilization configuration as a Hard resource, performing one or more actions to determine the frequency-domain resource usage in such a manner as to mitigate the interference comprises:
determining to use the frequency part according to its configuration as a Hard resource irrespective of an impact of such use on an ability of the IAB-MT to transmit or receive in the same frequency part only if such use does not impact an ability of the IAB-MT to transmit and receive in any other frequency part; or
determining to use the frequency part according to its configuration as a Hard resource irrespective of an impact of such use on an ability of the IAB MT to transmit or receive in any frequency part.

30. The method of claim 28 wherein, for a frequency part that is indicated by the frequency-domain resource utilization configuration as a Soft resource, performing the one or more actions to determine the frequency-domain resource usage in such a manner as to mitigate the interference comprises:
determining to use the frequency part according to its configuration as a Soft resource only if such use does not impact an ability of the IAB-MT to transmit or receive in any frequency part; or
determining to use the frequency part according to its configuration as a Soft resource only if such use does not impact an ability of the IAB-MT to transmit or receive in the same frequency part.

31. The method of claim 28 wherein, for a frequency part that is indicated by the frequency-domain resource utilization configuration as a Not Available resource, performing the one or more actions to determine the frequency-domain resource usage in such a manner as to mitigate the interference comprises determining not to use the frequency part according to its configuration as a Not Available resource.

32-36. (canceled)

37. An Integrated Access and Backhaul node comprising processing circuitry configured to cause the IAB node to:
receive a frequency-domain resource utilization configuration from a network node, the frequency-domain resource utilization configuration comprising information that indicates a mode of frequency-domain resource utilization for each of at least some of a plurality of frequency parts of an available bandwidth of the IAB node; and
determine a frequency-domain resource usage of an IAB Mobile Termination unit (IAB-MT) of the IAB node and an IAB Distributed Unit (IAB-DU) of the IAB node based on the frequency-domain resource utilization configuration.

38-41. (canceled)
